(19) United States
(12) Patent Application Publication
(10) Pub. No.: US 2008/0164096 A1
(43) Pub. Date: Jul. 10, 2008

(54) Roping Devices

(76) Inventor: Boris Rogelja, New South Wales (AU)

Correspondence Address: BOZICEVIC, FIELD & FRANCIS LLP, 1900 UNIVERSITY AVENUE, SUITE 200, EAST PALO ALTO, CA, 94303, US

(21) Appl. No.: 10/592,637

(22) PCT Filed: Mar. 17, 2005
(86) PCT No.: PCT/AU2005/000385

§ 371 Date: Mar. 7, 2008

(30) Foreign Application Priority Data
Mar. 22, 2004 (AU) 2004901507

(51) Int. Cl. A62B 1/14

(52) U.S. Cl. 182/5

(57) ABSTRACT

A roping device for operating on a rope includes a first body portion (11) providing an attachment means (34) at one end, the body portion (11) including a first plate (18) having a front face and a reverse face and a second plate (20) having a front face and a reverse face. The plates (18, 20) are oriented in different planes defining an acute angle between the intersection of those planes. A first rotatable sheave (12) is mounted on the front face of the second plate (20) rotatable about an axis which is substantially perpendicular to the second plate. The first sheave (12) has a groove defining a generally semi-circular rope guide path having a first end and a second end. The first end of the guide path opens onto the front face of the first plate, and the second end of the guide path opens onto the reverse face of the first plate (18). The front face of the first plate defines a generally straight guide path in the form of a channel 21 along which the rope passes prior to the generally semi-circular guide path. A braking means (24) is mounted on the front face of the first plate (18).

### FIELD OF THE INVENTION

The present invention relates to improved roping devices and in particular, to devices which are suitable for use by a person who wishes to safely descend a shear face of a building, cliff or the like.

### BACKGROUND OF THE INVENTION

If a person needs to descend from a height, by for example, climbing down a ladder, cliff face or the like, for safety reasons, it is often necessary for the person to be attached in someway to the ladder or to a convenient securing point, so that in the event that the person slips and falls, he or she will be prevented from falling to the ground. Clearly, any device for this purpose should preferably be as small and unobtrusive as possible, in use, to allow the user to make the decent without significant interference.

Such roping devices are often used by workers such as window cleaners and other workers maintaining the exteriors of sky scrapers and the like.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

### SUMMARY OF THE INVENTION

In a first aspect, the present invention provides a roping device for operating on a rope comprising:

a first body portion providing an attachment means at one end, the body portion including a first plate having a front face and a reverse face and a second plate having a front face and a reverse face, wherein the plates are oriented in different planes defining an acute angle between the intersection of the planes;

a first, freely rotatable sheave mounted on the front face of the first plate which is rotatable about an axis which is substantially perpendicular the first plate, the first sheave having an annular groove defining a generally semi-circular guide path for the rope, the guide path having a first end and a second end, and wherein the first end of the guide path opens onto the front face of the second plate, and the second end of the guide path opens onto or adjacent the reverse face of the second plate;

a generally straight guide path in the form of a channel or the like, defined on the front face of the second plate along which the rope passes prior to the generally semi-circular guide path, and vice versa; and

a braking mechanism mounted on the front face of the second plate, the braking mechanism being arranged for braking the rope which in use, passes along generally straight guide path, the braking mechanism being biased towards an engaged position wherein the rope is prevented from moving in a first direction through the device, and including means for moving the braking means out of engagement with the rope to allow the rope to pass freely along the guide path.

Preferably the diameter of the first sheave is less than the width of the second plate.

By orienting the plates as described above the rope leaving the semicircular guide path passes behind the second plate. This has the advantage that the rope does not abrade against the first plate and any formations on the same. Thus the first sheave can be made smaller than would otherwise be required to avoid abrasion of the rope and does not need to be oversized. The diameter of the first sheave may be as little as 4 to 5 cm compared to the width of the second plate of 7.5 cm.

In one embodiment, the device includes a second sheave disposed on a reverse face of the first plate and rotatable about an axis projecting normally to the first plate.

Alternatively, one or more additional sheaves may be disposed on the reverse side of the second plate, being rotatable about an axis projecting normally to the second plate.

Typically, the angle defined between the first plate and the second plate is about 15-30° most preferably around 20-25°.

The device preferably includes an associated sheave block including one or more axially aligned sheaves, the sheaves including attachment means such an aperture for attaching a carabineer of the like and attaching a persons harness to the sheave block.

In use, the device is generally two-man operated with an operator located adjacent the roping device controlling the braking mechanism and a worker attached to the sheave block whose position is controlled by a rope attached to an attachment point at the lower end of the roping device, passing through the sheave block and up to the roping device, one or more times depending on the number of sheaves in the block and the desired mechanical advantage.

Whilst the above device is small and unobtrusive it does require two men to operate it.

Thus in a second aspect of the present invention, there is provided a roping device for operating on the rope, the device comprising:

a generally elongate body, including a first plate having a front face and a reverse face;

attachment means defined at one end of the first plate;

a first rotatable sheave mounted on the rear face of the first plate;

the front face defining a generally straight guide path for the rope, typically in the form of a channel, the guide path having a first end and a second end;

a second attachment means;

a braking mechanism mounted on the front face of the plate generally adjacent the guide path, the braking mechanism being arranged for selectively braking the rope, which in use, passes along the guide path then through the braking mechanism, said braking mechanism being biased towards an engaged position when the rope is prevented from moving in a first direction through the device and including means for moving the braking means out of engagement with the rope to allow the rope to pass freely along the guide path.

The device is typically used with a sheave block defining one or more sheaves. A second sheave, coaxial with the first sheave may be provided.

In use, a rope is attached to the first attachment means on the roping device passes up and around a sheave of the sheave block and back to the roping device then passes along the path adjacent the braking mechanism. The sheave block includes attachment means for attaching a sheave block to a secure attachment point. A person descending from a height attaches themselves to the second attachment means on the roping device and being adjacent the braking mechanism of the rope can easily adjust and control the mechanism to control their decent without assistance from a second person.

In a preferred embodiment the second attachment means is defined in a second plate which is oriented at an acute angle of about 20 to 25° to the first plate and in use lies beneath the fist sheave.

The sheaves are preferably freely rotatable.

### BRIEF DESCRIPTION OF THE DRAWINGS

A specific embodiment of the present invention will now be described by way of example only and with reference to the accompanying drawings in which:

FIG. 1 shows a first roping device and associated sheave block;

FIG. 1a is a diagram of the roping device of FIG. 1;

FIG. 2 is a side view of the roping device shown in FIG. 1;

FIG. 3 shows a second embodiment of a roping device and sheave block for single person operation;

FIG. 4 shows an enlarged view of the roping device of FIG. 3;

FIG. 5 shows a side view of the roping device shown in FIG. 4; and

FIG. 6 is an end view of the roping device of FIG. 3.

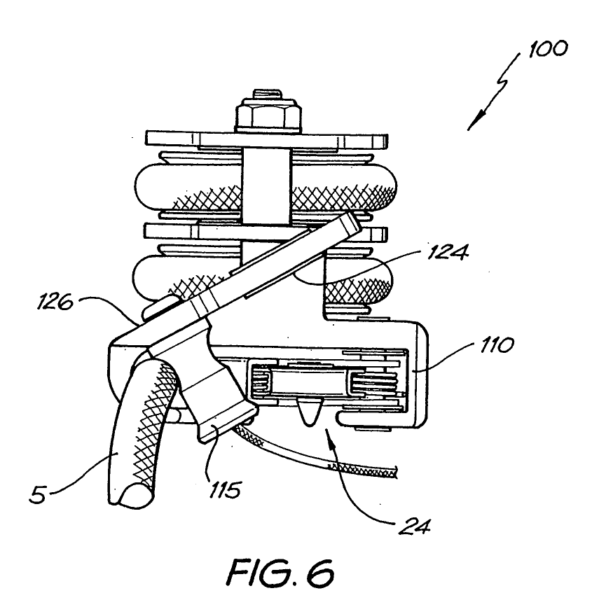

### DETAILED DESCRIPTION OF A PREFERRED EMBODIMENT

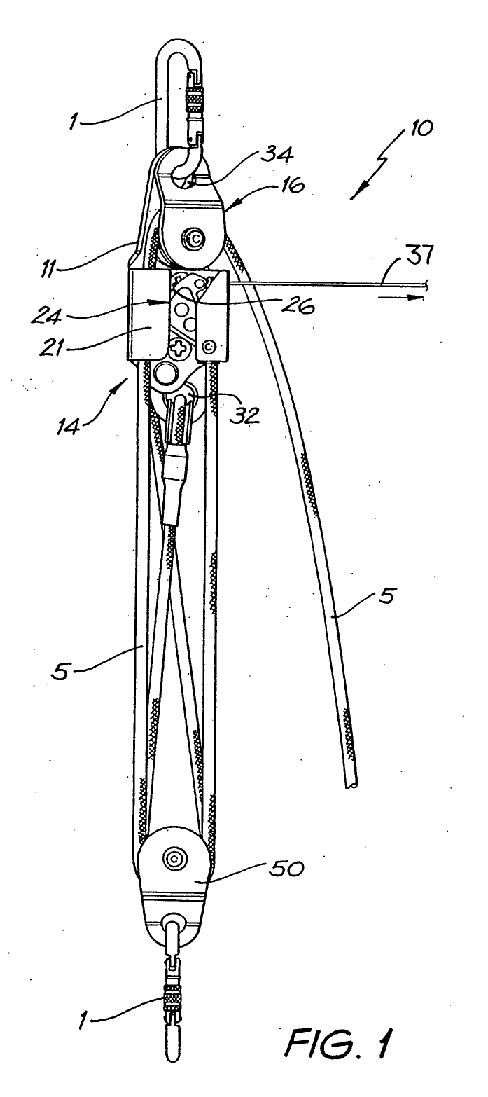

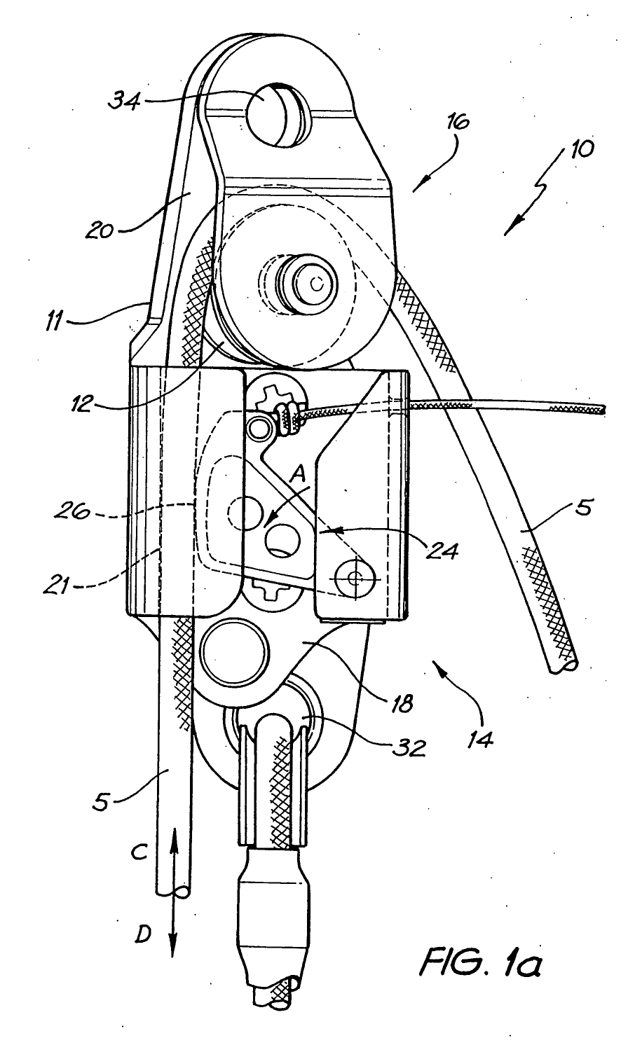

Referring to the drawings, FIG. 1 shows a first roping device generally indicated at 10 comprising a body portion 11, a first rotatable sheave 12 (hidden and shown in dashed outline in Figure la). The body is generally elongate and has two distinct sections 14 and 16. Both body sections define a flat plate being first and second flat plates 18 and 20, respectively.

As is best seen in FIG. 1a, the lower part 14 of the roping device defines a part of a guide path for a rope 5 including a generally U-shaped channel 21 which extends along one side of the plate 18. A braking mechanism 24 is mounted on the side of the plate which defines the channel and defines a curved braking surface 26 which is adapted to frictionally engage the rope 5. The surface 26 defines an array of small spikes (not illustrated in the drawings). The braking member 24 is biased in the direction A into an engaged position in which a rope 5 passing along the guide path is wedged between the braking surface 26 and an opposing part of the U-shaped channel 21 preventing the rope from being pulled in the direction D. When a tension force is applied in the opposite direction C, the braking member 26 allows the rope to freely pass through the U-shaped channel 21. In a variant (not shown), the braking mechanism 24 also includes a latch pivotally mounted on the braking member which can be moved against the biasing force into an open position into a fully retracted position.

The device 10 includes first and second attachment points 34, 32 in the form of holes in the first and second plates, respectively. Hole 34 is intended to allow the user to connect the device by way of a karabiner 1 to a rung of a ladder or other convenient fixing point. As shown in FIG. 1 the other hole 32 can be used to connect one end of the rope 5 to the device 10 when it is being used as a part of a block and tackle arrangement as shown in FIG. 1 of the drawings.

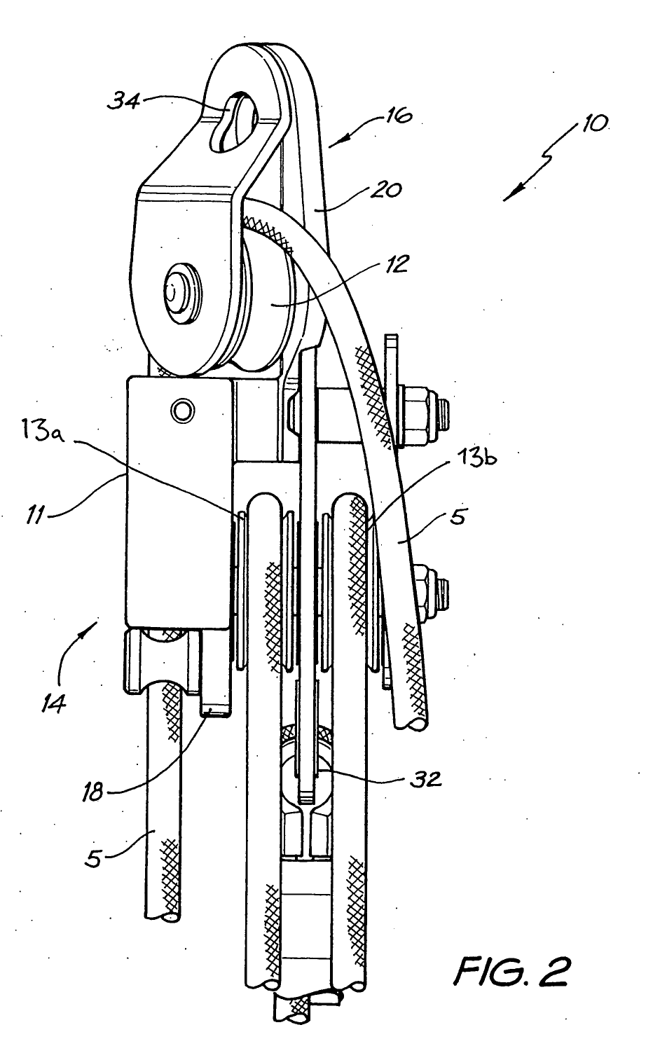

As illustrated in FIG. 2 in particular, the plate 18 lies in a plane which meets the plate 20 at an acute angle of approximately 20-25°. Because of this, the rope 5 passing around the sheave 12 can pass behind the part 14 of the roping device avoiding contact with the front part of the roping device and preventing wear and tear on the rope. This arrangement also allows sheave 12 to be much smaller than what would otherwise be required to prevent abrasion of the rope 5 in use. The sheave is about 4.5 cm in diameter which is narrower than the width of the plate 18 which is about 7.5 cm.

FIG. 2 also shows two additional co-axial rotatable sheaves 13a and 13b located on the reverse face of the first plate 18 for use with a block an tackle arrangement to increase mechanical advantage. In a variant, one or two additional sheaves could instead be located behind the second plate 20.

As shown in FIG. 1, the device 10 is used in conjunction with a sheave block 50 having first and second sheaves and which is attached by way of a karabiner 1 to the person or object being lowered. One end of the rope is attached to the attachment point 32 of the device. The rope extends down to the sheave block, around one sheave, back up to the device 10, around to the sheave 13a, passing behind the plate 20, around down to the first sheave of the sheave block, up towards the roping device, around the sheave 13b, down to the sheave block 12 through the channel 21 and braking mechanism 24. The tail end of the rope should be free to feed into the device as the user descends. In FIG. 1 tension t is applied to a length of string 37, pulling the braking mechanism out of engagement to allow the rope to freely run through the channel 21.

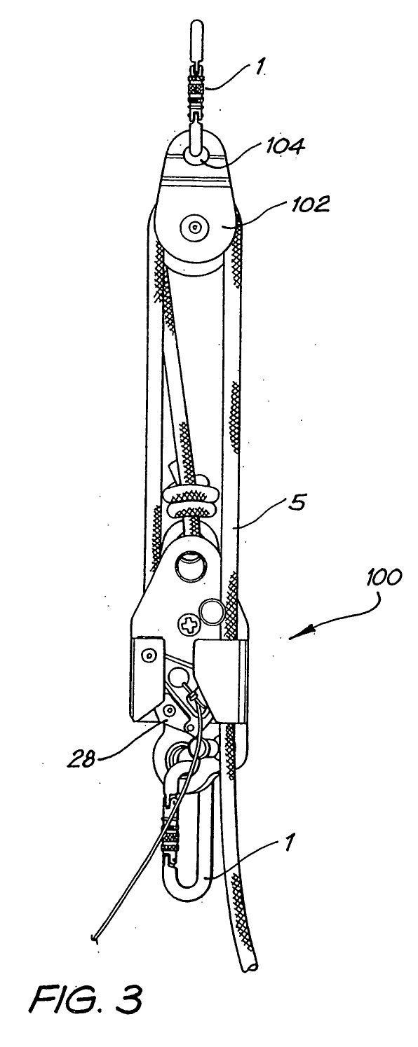

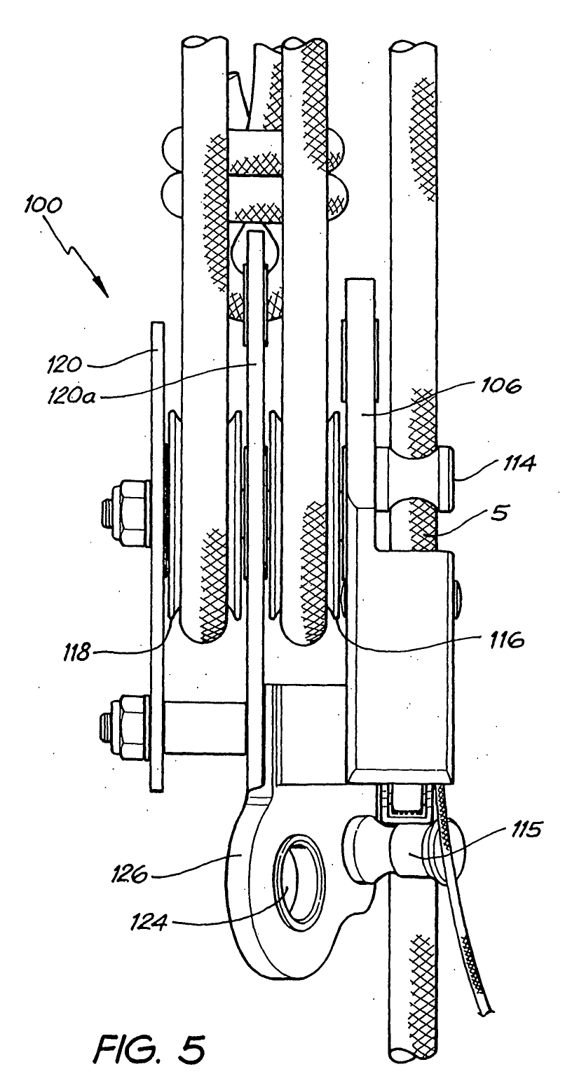

A second embodiment of a roping device 100 is shown in FIGS. 3 to 5. In contrast with the first roping device, this device can be operated by a single person. The roping device 100 is used in conjunction with a sheave block 102 having three rotatable sheaves. The sheave block 102 defines an attachment point 104 in the form of a hole which is attached by way of a karabiner 1 to a rung of a ladder or other secure attachment point.

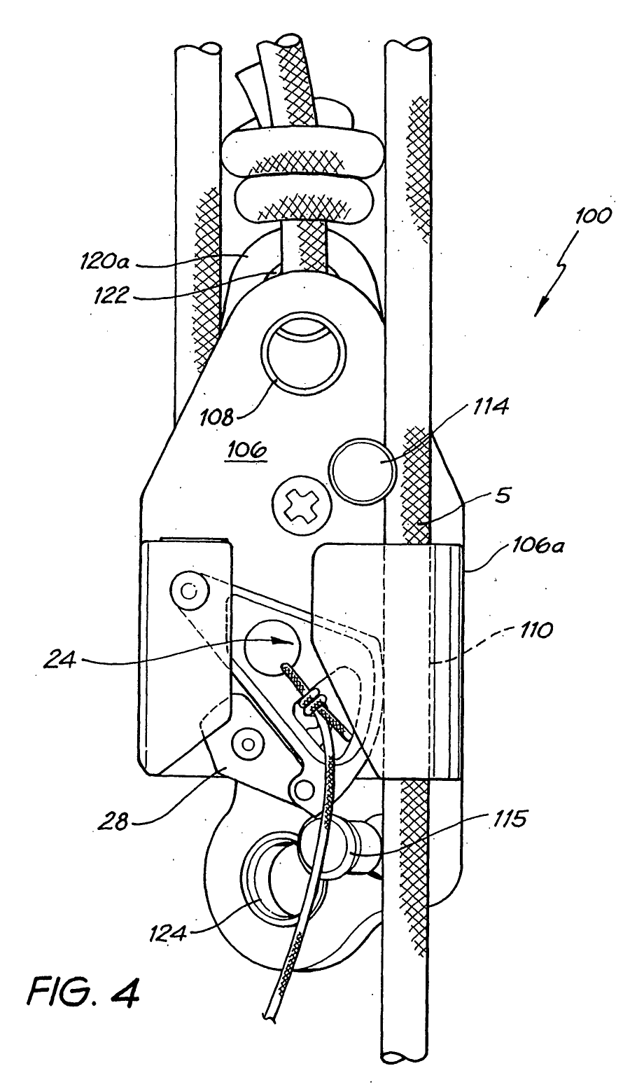

Roping device 100 is shown in more detail in FIG. 4. The device defines a front plate 106 which defines an attachment point 108 in the form of a hole at one end. The front plate defines a generally U-shaped channel 110 extending at a predetermined distance along a side edge 106a of the plate. The device includes a braking mechanism 24 which is identical to the braking mechanism described in relation to the first embodiment and will not be described in detail in relation to this embodiment. Bosses 114 and 115 help control the path of a rope 5 through the device and to contain the rope 5 in the channel 110. Two rotatable sheaves 116 and 118 are disposed behind the plate 106 for rotation about an axis which is perpendicular to the plate 106. A plate 120 is disposed between the two sheaves. The upper end 120a of the plate, in use, defines an attachment point 122 in the form of a hole which projects further than the attachment point 108 defined in the plate 106.

A second attachment point 124 is defined at the base of the roping device in use. This is defined in a plate 126 which extends from the longitudinal edge 106a away from the front plate at an acute angle to the same of approximately 20-25°. In this way, the attachment point defined at the lower end of the device in use, is located generally towards the centre of the roping device and this improves the balance and stability of the apparatus, in use.

In use as shown in FIG. 3 a worker attaches the attachment point 104 of the sheave block 50 to a secure attachment point define on the building or the like which they are to descend. The roping device 100 is attached by way of a further karabiner to their harness. The worker can easily control the braking mechanism 24 to allow rope to pass through the guide channel 110 when descending.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A roping device for operating on a rope comprising:
a first body portion providing an attachment means at one end, the body portion including a first plate having a front face and a reverse face and a second plate having a front face and a reverse face, wherein the plates are oriented in different planes defining an acute angle between the intersection of the planes;
a first, freely rotatable sheave mounted on the front face of the second plate which is rotatable about an axis which is substantially perpendicular to the second plate, the first sheave having a groove defining a generally semi-circular guide path for the rope, the guide path having a first end and a second end, and wherein the first end of the guide path opens onto the front face of the first plate, and the second end of the guide path opens onto or adjacent the reverse face of the first plate;
a generally straight guide path in the form of a channel or the like, defined on the front face of the first plate along which the rope passes prior to the generally semi-circular guide path, and vice versa; and
a braking mechanism mounted on the front face of the first plate, the braking mechanism being arranged for braking the rope which in use, passes along the generally straight guide path, the braking mechanism being biased towards an engaged position wherein the rope is prevented from moving in a first direction through the device, and including means for moving the braking mechanism out of engagement with the rope to allow the rope to pass freely along the guide path.

2. A roping device as claimed in claim 1 wherein the diameter of the first sheave is less than the width of the first plate.

3. A roping device as claimed in claim 1 wherein the device includes a second sheave disposed on a reverse face of the first plate and rotatable about an axis projecting normally to the first plate.

4. A roping device as claimed in claim 1 wherein the angle defined between the first plate and the second plate is from 15 to 30°.

5. A roping device as claimed in claim 1 wherein the angle defined between the first plate and the second plate is from 20 to 25°.

6. A roping device as claimed in claim 1 further including an associated sheave block including one or more axially aligned sheaves, the sheaves including attachment means such an aperture for attaching a carabineer of the like and attaching a persons harness to the sheave block.

7. A roping device for operating on the rope, the device comprising:
a generally elongate body, including a first plate having a front face and a reverse face;
attachment means defined at one end of the first plate;
a first rotatable sheave mounted on the rear face of the first plate;
the front face defining a generally straight guide path for the rope, typically in the form of a channel, the guide path having a first end and a second end;
a second attachment means;
a braking mechanism mounted on the front face of the plate generally adjacent the guide path, the braking mechanism being arranged for selectively braking the rope, which in use, passes along the guide path then through the braking mechanism, said braking mechanism being biased towards an engaged position when the rope is prevented from moving in a first direction through the device and including means for moving the braking means out of engagement with the rope to allow the rope to pass freely along the guide path.

8. A roping device as claimed in claim 7 wherein the second attachment means is defined in a second plate which is oriented at an acute angle of about 20 to 25° to the first plate and in use lies beneath the fist sheave.

9. A roping device as claimed in claim 7 wherein the sheaves are freely rotatable.
